(19) United States
(12) Patent Application Publication
(10) Pub. No.: US 2008/0307620 A1
(43) Pub. Date: Dec. 18, 2008

(54) Thin-film capacitor, laminated structure and methods of manufacturing the same

(75) Inventors: Jung-Won Lee, Seoul (KR); Yul-Kyo Chung, Yongin-si (KR); In-Hyung Lee, Seoul (KR); Byung-lk Song, Suwon-si (KR); Seung-Eun Lee, Seongnam-si (KR)

Correspondence Address: STAAS & HALSEY LLP, SUITE 700, 1201 NEW YORK AVENUE, N.W., WASHINGTON, DC, 20005, US

(73) Assignee: SAMSUNG ELECTRO-MECHANICS CO., LTD., Suwon (KR)

(21) Appl. No.: 12/213,366

(22) Filed: Jun. 18, 2008

(30) Foreign Application Priority Data
Jun. 18, 2007 (KR) 10-2007-0059482

(51) Int. Cl. H01G 4/008; H01G 9/04

(52) U.S. Cl. 29/25.03; 361/305

(57) ABSTRACT

Disclosed are an embedded capacitor and a printed circuit board including the same that can minimize the oxidization of a metal layer. A thin-film capacitor can include a first metal electrode film; a barrier layer, formed on the first metal electrode film to include a conductive oxide; a dielectric film, formed on the barrier layer; and a second metal electrode film, formed on the dielectric film. With the present invention, the outstanding characteristic of a ferroelectric thin film can be provided by minimizing the oxidization of a copper film in the heat treatment after forming the ferroelectric thin film on the copper film.

### CROSS-REFERENCE TO RELATED PATENT APPLICATIONS

This application claims the benefit of Korean Patent Application No. 10-2007-0059482, filed on Jun. 18, 2007, in the Korean Intellectual Property Office, the disclosure of which is incorporated herein in its entirety by reference.

### BACKGROUND OF THE INVENTION

1. Field of the Invention

The present invention relates to an embedded capacitor, more specifically to an embedded capacitor and a printed circuit board including the same that can minimize the oxidization of a metal layer.

2. Background Art

The developed high-frequency and miniaturization of a laminated board has made various kinds of passive elements included in the conventional printed circuit board considered as big obstructing factors. In particular, the increased number of embedded semiconductor active elements and their input/output ports require more spaces acquired by the passive elements around each of the active elements. This is not the problem that can be easily solved.

One of well-known passive elements is a capacitor. The capacitors need to have the suitable configuration in order to reduce the inductance as a high frequency band is used as an operating frequency. For example, a decoupling capacitor used for stably supplying a power is required to be arranged closest to an input port in order to reduce the inductance as a high frequency band is used.

In order to meet the requirement of the developed high-frequency and miniaturization, various types of low equivalent-series-inductance (ESL) laminated capacitors have been developed by allowing the capacitors to be mounted below active elements and reducing an inductance value of a chip. However, a limit is placed on the conventional multi-layer ceramic capacitor (MLCC), which is a discrete element, to solve the problem.

The embedded capacitor, which is embedded in a printed circuit board used for a memory card, a PC main board and various types of RF modules, can reduce the size of a product. Also, since it is possible that one layer placed below an active element is formed as a dielectric layer and arranged near to an input part of the active element, the inductance can be decreased by minimizing the length of electrical lines.

Since the printed circuit board includes a polymer-based complex having a low permittivity, it is difficult to form a layer having a higher permittivity. Some technologies can improve the permittivity a little by scattering ferroelectric powder such as BaTiO₃ on a polymer layer such as FR4 used for a printed circuit board. However, in the case of applying a decoupling capacitor using a polymer-based complex material, it is impossible to embed the decoupling capacitor in a product having the small size of a package level due to the limit of the electric capacity.

It may be considered as an alternative method that the thin-film capacitor including a dielectric film having a high permittivity and a metal electrode film is inserted into the printed circuit board as the laminated structure. Here, the materials used for the dielectric film includes ferroelectric materials and paraelectric materials.

While the ferroelectric material has a remarkably large dielectric constant, the heat treatment of high temperature of 550° C. or higher is required to be performed to provide the ferroelectric characteristic. However, the printed circuit board including polymer-based complexes is easily affected by the high temperature, it is impossible to supply the high temperature of 550° C. or higher in the manufacturing process.

Accordingly, it may be considered as an alternative method that the thin-film is formed by undergoing the heat treatment of high temperature after vapor-depositing a ferroelectric thin film on a copper film without a polymer. The copper film, however, may be easily oxidized in the heat treatment, to thereby deteriorate the characteristic of the ferroelectric thin film. Thus, it is required to prevent the oxidization by adjusting oxygen partial pressure when using a barrier layer made of nickel alloy or performing the heat treatment.

### SUMMARY OF THE INVENTION

Accordingly, the present invention provides a thin-film capacitor and a method of manufacturing the same that includes a new oxide barrier layer which can provide the dielectric characteristic of a good ferroelectric thin film by minimizing the oxidization of a copper film in the heat treatment after forming the ferroelectric thin film on the copper film.

The present invention also provides a thin-film capacitor and a method of manufacturing the same that includes a dielectric film which can have the high electric capacity by preventing the oxidization of a copper film and enhancing the interfacial property.

The present invention also provides a thin-film capacitor and a method of manufacturing the same that includes a thin-film capacitor which can have the high electric capacity by preventing the oxidization of a copper film and enhancing the interfacial property.

An aspect of the present invention features a thin-film capacitor including a first metal electrode film; a barrier layer, formed on the first metal electrode film to include a conductive oxide; a dielectric film, formed on the barrier layer; and a second metal electrode film, formed on the dielectric film.

Here, the barrier layer can be formed to include at least one conductive oxide selected from a group including indium tin oxide (ITO), zinc oxide (ZnO), lanthanum nickel oxide (LNO) and ruthenium oxide (RuO₂).

The dielectric film can be formed to include a Pb-system or Ba-system metal oxide.

At least one of the first metal electrode film and the second metal electrode film can be formed to include at least one metal selected from a group including Cu, Ni, Al, Pt, Ta, Ti and Ag.

Another aspect of the present invention features a laminated structure including a first metal electrode film, formed on a polymer-complex-based material; a barrier layer, formed on the first metal electrode film to include a conductive oxide; a dielectric film, formed on the barrier layer; and a second metal electrode film, formed on the dielectric film.

Here, the barrier layer can be formed to include at least one conductive oxide selected from a group including indium tin oxide (ITO), zinc oxide (ZnO), lanthanum nickel oxide (LNO) and ruthenium oxide (RuO₂).

The dielectric film can be formed to include a Pb-system or Ba-system metal oxide.

At least one of the first metal electrode film and the second metal electrode film can be formed to include at least one metal selected from a group including Cu, Ni, Al, Pt, Ta, Ti and Ag.

Anther aspect of the present invention features a method of manufacturing a thin-film capacitor including forming a barrier layer on the first metal electrode film to include a conductive oxide; forming a dielectric film on the barrier layer; and forming a second metal electrode film on the dielectric film.

Here, the forming the barrier layer can be performed by using a sputtering method, a physical vapor deposition (PVD) method, a chemical vapor deposition (CVD) method, and/or a sol-gel method.

The forming the dielectric layer can be performed by using heat treatment of 550° C. or higher.

The forming the dielectric layer can be performed by using a sputtering method, a physical vapor deposition (PVD) method, a chemical vapor deposition (CVD) method, and/or a sol-gel method.

Here, the barrier layer can be formed to include at least one conductive oxide selected from a group including indium tin oxide (ITO), zinc oxide (ZnO), lanthanum nickel oxide (LNO) and ruthenium oxide (RuO₂).

The dielectric film can be formed to include a Pb-system or Ba-system metal oxide.

At least one of the first metal electrode film and the second metal electrode film can be to include at least one metal selected from a group including Cu, Ni, Al, Pt, Ta, Ti and Ag.

Another aspect of the present invention features a method of manufacturing a laminated structure including forming a first metal electrode film on a polymer-complex-based material; forming a barrier layer on the first metal electrode film to include a conductive oxide; forming a dielectric film on the barrier layer; and forming a second metal electrode film on the dielectric film.

Here, the step of forming the barrier layer can be performed by using a sputtering method, a physical vapor deposition (PVD) method, a chemical vapor deposition (CVD) method, and/or a sol-gel method.

The forming the dielectric layer can be performed by using heat treatment of 550° C. or higher.

The forming the dielectric layer can be performed by using a sputtering method, a physical vapor deposition (PVD) method, a chemical vapor deposition (CVD) method, and/or a sol-gel method.

Here, the barrier layer can be formed to include at least one conductive oxide selected from a group including indium tin oxide (ITO), zinc oxide (ZnO), lanthanum nickel oxide (LNO) and ruthenium oxide (RuO₂).

The dielectric film can be formed to include a Pb-system or Ba-system metal oxide.

At least one of the first metal electrode film and the second metal electrode film can be formed to include at least one metal selected from a group including Cu, Ni, Al, Pt, Ta, Ti and Ag.

### BRIEF DESCRIPTION OF THE DRAWINGS

These and other features, aspects and advantages of the present invention will become better understood with regard to the following description, appended Claims and accompanying drawings where:

FIG. 1 is a sectional view showing a thin-film capacitor;

FIGS. 2A through 2C are sectional views showing a method of manufacturing a thin-film capacitor;

FIG. 3 is a sectional view showing the conventional thin-film capacitor using a barrier layer made of nickel alloy;

FIG. 4 is a graph showing the dielectric characteristic of a thin-film capacitor of FIG. 3;

FIG. 5 is a sectional view showing a thin-film capacitor using a barrier layer made of a conductive oxide in accordance with an embodiment of the present invention; and

FIG. 6 is a graph showing the dielectric characteristic of a thin-film capacitor of FIG. 5.

### DESCRIPTION OF THE EMBODIMENTS

Since there can be a variety of permutations and embodiments of the present invention, certain embodiments will be illustrated and described with reference to the accompanying drawings. This, however, is by no means to restrict the present invention to certain embodiments, and shall be construed as including all permutations, equivalents and substitutes covered by the spirit and scope of the present invention. Throughout the drawings, similar elements are given similar reference numerals. Throughout the description of the present invention, when describing a certain technology is determined to evade the point of the present invention, the pertinent detailed description will be omitted.

Terms such as “first” and “second” can be used in describing various elements, but the above elements shall not be restricted to the above terms. The above terms are used only to distinguish one element from the other.

The terms used in the description are intended to describe certain embodiments only, and shall by no means restrict the present invention. Unless clearly used otherwise, expressions in the singular number include a plural meaning. In the present description, an expression such as,“comprising” or “consisting of” is intended to designate a characteristic, a number, a step, an operation, an element, a part or combinations thereof, and shall not be construed to preclude any presence or possibility of one or more other characteristics, numbers, steps, operations, elements, parts or combinations thereof.

Hereinafter, some embodiments of the present invention will be described in detail with reference to the accompanying drawings.

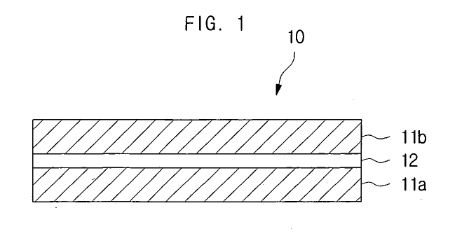

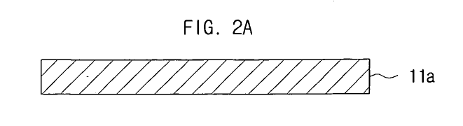

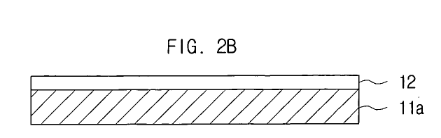

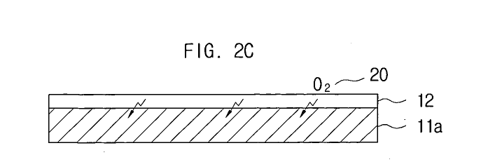

FIG. 1 is a sectional view showing a thin-film capacitor, and FIGS. 2A through 2C are sectional views showing a method of manufacturing a thin-film capacitor.

A thin-film capacitor is illustrated in FIG. 1.

The thin-film capacitor 10 can be an embedded capacitor embedded in a printed circuit board including a polymer-complex-based material. The polymer-complex-based material can be polyimide or epoxy, which are often used for a printed circuit board.

The thin-film capacitor 10 includes a first metal electrode film 11a, a second metal electrode film 11b and a dielectric film 12, which is an oxide ceramic, placed therebetween.

The dielectric film 12 is formed to include a Pb-system or Ba-system metal oxide having the ferroelectric characteristic. In accordance with an embodiment of the present invention, the dielectric film 12 is formed to include a Pb-system metal oxide represented as PbₓZr_{y}Ti_{z}O₃. Alternatively, it is possible to use a Ba-system metal oxide. The dielectric film 12 can have the thickness of 50 nm˜1 μm in order to be applied to a printed circuit board as an embedded capacitor. The dielectric film 12, which is an embedded capacitor of a printed circuit board, for example, can be formed by a sputtering method, a physical vapor deposition (PVD) method, a chemical vapor deposition (CVD) method, and/or a sol-gel method.

At least one of a first metal oxide film 11a and a second metal oxide film 11b can be formed to include at least one metal selected from a group including Cu, Ni, Al, Pt, Ta, Ti and Ag. The first metal oxide film 11a and the second metal oxide film 11b can be formed by evaporation including vacuum evaporation, sputtering or electroless planting.

Below is the method of manufacturing a thin-film capacitor 10.

The first metal electrode film 11a is provided (refer to FIG. 2A). The first metal oxide film is formed to include at least one metal selected from a group including Cu, Ni, Al, Pt, Ta, Ti and Ag.

The dielectric film 12 is formed on the first metal electrode film 11a to include a Pb-system or Ba-system metal oxide (refer to FIG. 2B). In accordance with an embodiment of the present invention, the dielectric film 12 is formed to include a metal oxide represented as PbₓZr_{y}Ti_{z}O₃. The dielectric film 12 can have the thickness of 50 nm˜1 μm in order to be applied to a printed circuit board as an embedded capacitor. The dielectric film 12, which is an embedded capacitor of a printed circuit board, for example, can be formed by using a sputtering method, a physical vapor deposition (PVD) method, a chemical vapor deposition (CVD) method, and/or a sol-gel method.

Then, the metal electrode film 11b can be formed on the dielectric film 12 by using the similar material and process to the metal electrode film 11a.

Here, the heat treatment of high temperature of 550° C. or higher is performed to provide the ferroelectric characteristic of the dielectric film 12 before the second metal electrode film 11b is formed. In this case, the oxygen of the dielectric film 12 is transferred to the first metal electrode film 11a, to thereby oxidize the first metal electrode film 11a, as shown in FIG. 2C.

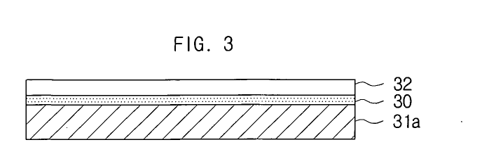

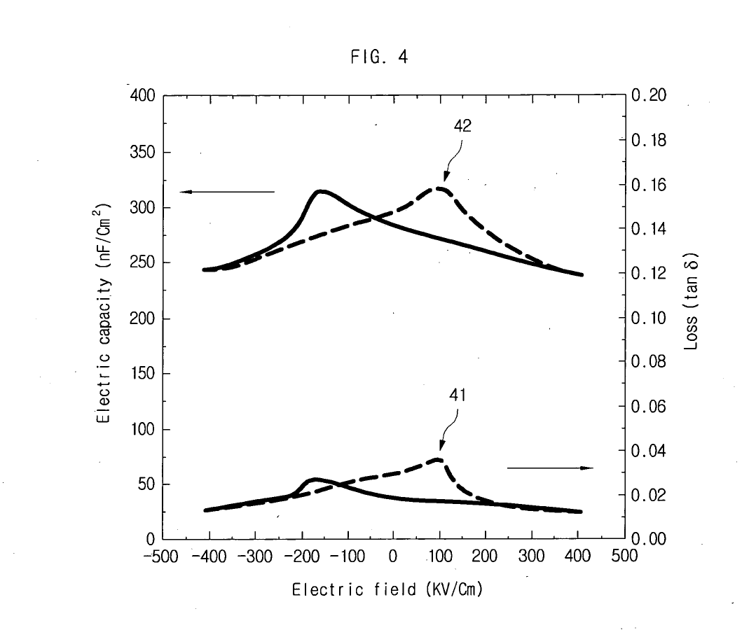

To prevent the first metal electrode film 11a from being oxidized, the section and the dielectric characteristic of the conventional thin-film capacitor using a barrier layer made of nickel alloy are illustrated in FIG. 3 and FIG. 4.

FIG. 3 is a sectional view showing the conventional thin-film capacitor using a barrier layer made of nickel alloy, and FIG. 4 is a graph showing the dielectric characteristic of a thin-film capacitor of FIG. 3.

Referring to FIG. 3, a nickel-allay barrier layer 30 can be formed between the first metal electrode film 31a and the dielectric film 32. The nickel-allay barrier layer 30 can be formed by a plating method.

In case that the first metal electrode film 31a is formed to include Pt to show the ferroelectric characteristic of the dielectric film 32, which is made of a PbZrTi-system metal oxide, very well, an interfacial layer may be formed by the reaction between the nickel-allay barrier layer 30 and the dielectric film 32. Accordingly, the electric capacity can have a low value of about 300 nF/cm² (refer to the reference number 42 of FIG. 4). The 300 nF/cm² is the very low value as compared with the dozens of μF/cm² required to be embedded in a printed circuit board and used. Here, the reference number 41 of FIG. 4 indicates the dielectric loss.

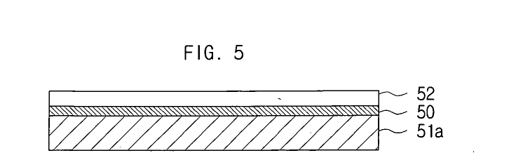

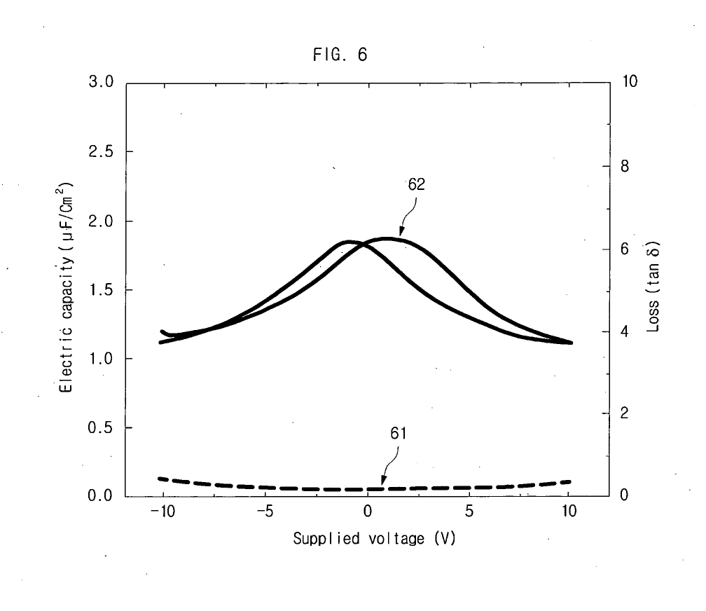

Accordingly, the present invention provides a new barrier layer that can prevent the metal electrode film from being oxidized and simultaneously have a large electric capacity. The section and the dielectric characteristic of the conventional thin-film capacitor using a barrier layer made of a conductive oxide are illustrated in FIG. 5 and FIG. 6.

FIG. 5 is a sectional view showing a thin-film capacitor using a barrier layer made of a conductive oxide in accordance with an embodiment of the present invention, and FIG. 6 is a graph showing the dielectric characteristic of a thin-film capacitor of FIG. 5.

Referring to FIG. 5, a barrier layer 50 can be formed between a first electrode film 51a and a dielectric film 52. The barrier layer 50 can have the thickness of 100 nm through 3 μm.

The barrier layer 50 is formed to include at least one conductive oxide selected from a group including indium tin oxide (ITO), zinc oxide (ZnO), lanthanum nickel oxide (LNO) and ruthenium oxide (RuO₂).

The barrier layer 50 can be formed on the first metal electrode film 51a by a sputtering method, a physical vapor deposition (PVD) method, a chemical vapor deposition (CVD) method, and/or a sol-gel method.

A dielectric film 52 can be formed on the barrier layer 50. At this time, the heat treatment is performed to provide the ferroelectric characteristic of the dielectric film 52.

Forming the barrier layer to include the conductive oxide makes it possible to prevent the first metal electrode film 51a from being oxidized in the heat treatment of the dielectric film and to have an influence on the enhancement of the interfacial property of the conductive oxide and the dielectric film 52.

The dielectric film 52 is formed to include a Pb-system or Ba-system metal oxide (refer to FIG. 2B). In accordance with an embodiment of the present invention, the dielectric film 52 is formed to include a metal oxide represented as PbₓZr_{y}Ti_{z}O₃. The dielectric film 52 can have the thickness of 50 nm˜1 μm in order to be applied to a printed circuit board as an embedded capacitor. The dielectric film 52, which is an embedded capacitor of a printed circuit board, for example, can be formed by using a sputtering method, a physical vapor deposition (PVD) method, a chemical vapor deposition (CVD) method, and/or a sol-gel method.

In case that the first metal electrode film 51a is formed to include Pt to show the ferroelectric characteristic of the dielectric film 52, which is made of a PbZrTi-system metal oxide, very well, the electric capacity can have a very high value of about 2 μF/cm² (refer to the reference number 62 of FIG. 6), which may be suitable for being embedded in a printed circuit board and used. Here, the reference number 61 of FIG. 6 indicates the dielectric loss.

In the present invention, it is possible to put in practical use a thin-film capacitor and a printed circuit board including the same that can prevent the oxidization between a metal electrode film and a dielectric film and simultaneously have a large electric capacity by using a barrier layer made of a conductive oxide.

Hitherto, although some embodiments of the present invention have been shown and described for the above-described objects, it will be appreciated by any person of ordinary skill in the art that a large number of modifications, permutations and additions are possible within the principles and spirit of the invention, the scope of which shall be defined by the appended claims and their equivalents.

What is claimed is:

1. A thin-film capacitor, comprising:
a first metal electrode film;
a barrier layer, formed on the first metal electrode film to include a conductive oxide;
a dielectric film, formed on the barrier layer; and
a second metal electrode film, formed on the dielectric film.

2. The thin-film capacitor of claim 1, wherein the barrier layer is formed to include at least one conductive oxide selected from a group including indium tin oxide (ITO), zinc oxide (ZnO), lanthanum nickel oxide (LNO) and ruthenium oxide (RuO₂).

3. The thin-film capacitor of claim 1, wherein the dielectric film is formed to include a Pb-system or Ba-system metal oxide.

4. The thin-film capacitor of claim 1, wherein at least one of the first metal oxide film and the second metal oxide film is formed to include at least one metal selected from a group including Cu, Ni, Al, Pt, Ta, Ti and Ag.

5. A laminated structure, comprising:
a first metal electrode film, formed on a polymer-complex-based material;
a barrier layer, formed on the first metal electrode film to include a conductive oxide;
a dielectric film, formed on the barrier layer; and
a second metal electrode film, formed on the dielectric film.

6. The laminated structure of claim 5, wherein the barrier layer is formed to include at least one conductive oxide selected from a group including indium tin oxide (ITO), zinc oxide (ZnO), lanthanum nickel oxide (LNO) and ruthenium oxide (RuO₂).

7. The laminated structure of claim 5, wherein the dielectric film is formed to include a Pb-system or Ba-system metal oxide.

8. The laminated structure of claim 5, wherein at least one of the first metal oxide film and the second metal oxide film is formed to include at least one metal selected from a group including Cu, Ni, Al, Pt, Ta, Ti and Ag.

9. A method of manufacturing a thin-film capacitor, comprising:
forming a barrier layer on the first metal electrode film to include a conductive oxide;
forming a dielectric film on the barrier layer; and
forming a second metal electrode film on the dielectric film.

10. The method of claim 9, wherein the forming the barrier layer is performed by using a sputtering method, a physical vapor deposition (PVD) method, a chemical vapor deposition (CVD) method, and/or a sol-gel method.

11. The method of claim 9, wherein the forming the dielectric layer is performed by using heat treatment of 550° C. or higher.

12. The method of claim 9, wherein the forming the dielectric layer is performed by using a sputtering method, a physical vapor deposition (PVD) method, a chemical vapor deposition (CVD) method, and/or a sol-gel method.

13. The method of claim 9, wherein the barrier layer is formed to include at least one conductive oxide selected from a group including indium tin oxide (ITO), zinc oxide (ZnO), lanthanum nickel oxide (LNO) and ruthenium oxide (RuO₂).

14. The method of claim 9, wherein the dielectric film is formed to include a Pb-system or Ba-system metal oxide.

15. The method of claim 9, wherein at least one of the first metal oxide film and the second metal oxide film is formed to include at least one metal selected from a group including Cu, Ni, Al, Pt, Ta, Ti and Ag.

16. A method of manufacturing a laminated structure, comprising:
forming a first metal electrode film on a polymer-complex-based material;
forming a barrier layer on the first metal electrode film to include a conductive oxide;
forming a dielectric film on the barrier layer; and
forming a second metal electrode film on the dielectric film.

17. The method of claim 16, wherein the forming the barrier layer is performed by using a sputtering method, a physical vapor deposition (PVD) method, a chemical vapor deposition (CVD) method, and/or a sol-gel method.

18. The method of claim 16, wherein the forming the dielectric layer is performed by using heat treatment of 550° C. or higher.

19. The method of claim 16, wherein the forming the dielectric layer is performed by using a sputtering method, a physical vapor deposition (PVD) method, a chemical vapor deposition (CVD) method, and/or a sol-gel method.

20. The method of claim 16, wherein the barrier layer is formed to include at least one conductive oxide selected from a group including indium tin oxide (ITO), zinc oxide (ZnO), lanthanum nickel oxide (LNO) and ruthenium oxide (RuO₂).

21. The method of claim 16, wherein the dielectric film is formed to include a Pb-system or Ba-system metal oxide.

22. The method of claim 16, wherein at least one of the first metal oxide film and the second metal oxide film is formed to include at least one metal selected from a group including Cu, Ni, Al, Pt, Ta, Ti and Ag.
